(19) United States
(12) Patent Application Publication
(10) Pub. No.: US 2026/0179810 A1
(43) Pub. Date: Jun. 25, 2026

(54) Power cable with water blocking composition

(71) Applicant: NEXANS, Courbevoie (FR)

(72) Inventors: Jan Øivind Hewitt, Halden (NO); Quentin Eyssautier, Hafslundsøy (NO); Ingrid Roen Velo, Jevnaker (NO); Gunnar Håkonseth, Halden (NO); Anton Akulichev, HALDEN (NO); Jan-Are Sundby, Sarpsborg (NO)

(21) Appl. No.: 19/426,224

(22) Filed: Dec. 19, 2025

(30) Foreign Application Priority Data
Dec. 23, 2024 (NO) 20241263

(51) Int. Cl. H01B 13/22; H01B 7/14; H01B 7/285; H01B 13/02; H01B 13/26; H01B 13/30

(52) U.S. Cl. CPC H01B 13/221; H01B 7/14; H01B 7/285; H01B 13/0285; H01B 13/228; H01B 13/26; H01B 13/30

(57) ABSTRACT

A method of manufacturing an electric power cable comprises providing a plurality of conductor elements, stranding the conductor elements to combine the conductor elements into at least one conductor layer to form a conductor, applying a water blocking composition to the conductor elements in a stranding region during the stranding, such that interstices between the conductor elements comprise the water blocking composition, heating the conductor elements before and/or during entering the stranding region to a first temperature, and scraping off a part of the water blocking composition to adjust a layer thickness of the water blocking composition on the at least one conductor layer to a predetermined level, wherein the water blocking composition is configured to prevent water ingress within the at least one cable element.

### TECHNICAL FIELD

The present invention relates to a method of manufacturing an electric power cable, a system for manufacturing an electric power cable, as well as an electric power cable. More particularly, it concerns a power cable comprising conductors with a water blocking composition, a system for applying such a composition during cable production, and a method for preventing water ingress into the conductor structure. This invention is especially relevant for power cables deployed in subsea environments, where extreme conditions demand enhanced water blocking capabilities to ensure long-term performance and reliability.

### BACKGROUND OF THE INVENTION

Subsea power cables play a critical role in transmitting electrical energy in offshore applications, including wind farms, oil and gas installations, and interconnectors between islands and coastal regions. In operation, these cables are subjected to extreme environmental conditions, including high hydrostatic pressure, mechanical stress, and prolonged exposure to water. One of the most significant challenges in subsea cable design is preventing water ingress, which may compromise electrical performance, accelerate corrosion, and shorten the operational lifespan of the power cable.

Modern subsea cables may incorporate conductors with concentric multilayer designs to balance high current-carrying capacity with structural flexibility. Such conductors typically consist of a central core of conductive material (e.g., copper or aluminum) surrounded by one or more enclosing conductor layers. While these designs have advantages for electrical performance and mechanical resilience, they may present specific vulnerabilities to water ingress. Water may penetrate through gaps between individual conductor elements in a conductor layer or at the interfaces between concentric conductor layers. Over time, this ingress may lead to electrical insulation degradation, corrosion, and increased resistance, particularly under the high-pressure conditions found in subsea environments.

To mitigate these risks, various water blocking measures have been employed. Traditional approaches include the application of water blocking tapes, swellable powders, or impregnated yarns on the outer surfaces of conductors or within the conductor. While such techniques can provide some protection, they may be inadequate for subsea applications. Moreover, these methods could hinder cable flexibility, increase bulk, or be difficult to implement consistently in complex conductor geometries.

WO 2020/234391 A1 discloses a power cable, wherein a water blocking composition is applied within or between conductor layers, such as by filling interstitial spaces or coating surfaces of conductor strands. The composition prevents water ingress by blocking pathways within the conductor structure.

Despite these advances, there remains a need for subsea power cables, manufacturing methods, and systems that incorporate robust water blocking compositions into a conductor structure of a power cable. Such innovations would significantly enhance the resistance of subsea power cables to water ingress, ensuring consistent electrical performance and structural integrity under the demanding conditions of subsea environments.

### SUMMARY OF THE INVENTION

Thus, the object of the invention is to propose an improved method of manufacturing an electric power cable, which has improved resistance to water ingress. This object is met by a method according to the features of independent claim 1. Advantageous embodiments and further improvements may be gathered from the dependent claims and the following description.

It is proposed a method of manufacturing an electric power cable, wherein the method comprises providing a plurality of conductor elements, stranding the conductor elements to combine the conductor elements into at least one conductor layer to form a conductor, applying a water blocking composition to the conductor elements in a stranding region during the stranding, such that interstices between the conductor elements comprise the water blocking composition, heating the conductor elements before and/or during entering the stranding region and/or the water blocking composition to a first temperature during the applying, and scraping off a part of the water blocking composition to adjust a layer thickness of the water blocking composition on the at least one conductor layer to a predetermined level, wherein the water blocking composition is configured to prevent water ingress within the at least one cable element.

The term “conductor element” may refer to a part of a conductor within a power cable, which may include a strand and/or a profile conductor. Depending on the intended operating voltage of the power cable, the number of layers may be suitably chosen. The phrase “at least one” covers both singular and plural implementations.

The stranding process involves twisting together the conductor elements to form one or a plurality of conductor layers. The conductor elements may be fed from spools or bobbins into a stranding apparatus. The feeding may involve guiding the individual conductor elements through pathways to provide a desired alignment and tension. The stranding apparatus then twists the conductor elements together, e.g. in a helical pattern around a central axis. When the conductor elements are twisted, they form concentric layers. The stranding apparatus may comprise a rotating head, through which the conductor elements are fed. This head may also be referred to as a stranding die or a conductor forming die. The stranding die may be nano diamond-coated to reduce die wear that would increase the conductor layer diameter. The individual conductor elements are brought together just after passing the stranding die in a linear flow process.

The water blocking composition is applied to the conductor elements during the stranding process. This may be achieved by injecting or spraying the composition into a space between the conductor elements in a region behind the stranding die, i.e. in a region the conductor elements enter after passing the stranding die, and before the respective conductor layer is completed. This region is referred to as the “stranding region”. In doing so, the water blocking composition may thus reach the interstices of the conductor elements and thus ensures complete filling. The water blocking composition may be supplied through a pump that is coupled with a source of the water blocking composition.

The method comprises heating the conductor elements before and/or during entering the stranding region and/or the water blocking composition to a first temperature during the applying. The conductor elements may, for example, be heated through the stranding die with a resistive heater or with hot liquid circulation. Also, the water blocking composition could be heated before being applied to the stranding region. The first temperature, i.e. the temperature to which the stranding region may be heated up, may be in the range of 60° C. to 150° C. Also, a scraping device explained below may be heated. This relates to a scraping device that is in contact with the current outermost conductor layer, also where no application of water blocking composition is done. This is to ensure better distribution of water blocking composition in the conductor layers and between the conductor elements.

The respective conductor layer that is created by stranding the conductor elements may be fed through one or more scraping devices. The scraping device may comprise an opening cross-section through which the conductor can pass. The scraping device may comprise metal rings, which may be referred to as scrapers, which may be hardened. This allows to reduce friction wear from, for example, copper or aluminium. When the respective conductor layer that is formed by the stranding process step is fed through the scraping device, excess water blocking composition is scraped off. This allows to achieve a water blocking composition layer as thin as possible. For example, the resulting thickness may be less than 0.5 mm, preferably down to 0.4 mm, more preferably down to 0.2 mm or even down to 0.1 mm.

Instead of just one, also a plurality of scraping devices may be used. This may refer to any conductor layer. Also, a single conductor layer may be scraped off by multiple scraping devices. For example, a first scraping device may be arranged at a first location in the manufacturing flow direction, while a second scraping device may be installed in a distance thereto along the manufacturing flow direction. The second scraping device may be used for controlling a final thickness of the water blocking composition coating.

If the water blocking composition is applied to a plurality of conductor layers, not each conductor layer may be subjected to a scraping device. For example, only the outermost conductor layer or some outermost conductor layers may be subjected to the one or more scraping devices. As discussed further below, not all conductor layers may be filled.

By heating the stranding die to indirectly heat the stranding region, and/or by using a heated water blocking composition and/or by heating the stranding region directly, the viscosity of the water blocking composition may be reduced. This improves the scraping-off of the water blocking composition as well as the penetration of the water blocking composition into all interstices, depending on the specific configuration of the water blocking composition.

Scraping off excess water blocking composition may refer to at least the outermost conductor layer that is produced. However, also other conductor layers may be subjected to scraping off the water blocking composition. By creating multiple conductor layers that enclose each other, water blocking composition in interstices between conductor elements in one layer may swell out due to the mechanical compression of the conductor layers. Thus, as an example, at the outermost layer excess water blocking composition may be present, which may be scraped off.

The method steps as presented above do not necessarily need to be conducted in order of appearance. The stranding, applying and heating may be conducted all at the same time or (directly) after each other at different relative locations in a cable manufacturing process. The application of the water blocking composition may be done with heated application heads that may also hold both the stranding die and the scraping device. Thus, the application and calibration of the water blocking composition coating may be done in one step at the relevant conductor layer(s).

As mentioned below, not each conductor layer requires the applying of the water blocking composition. The scraping off, however, may refer to only one conductor layer, a subset of the conductor layers or all conductor layers. Preferably, at least the outermost layer is treated by the scraping off.

The method according to the invention may include the formation of several conductor layers, such as 2, 3, 4, 5, 6 or even more conductor layers. The individual conductor layers are created by individual stranding dies, which are to be passed through one after the other, wherein each of the stranding die is designed to produce the respective conductor layer. Thus, the stranding dies that are to be passed through may incrementally increase in their sizes.

As explained further below, the water blocking composition does not need to be applied to each of the conductor layers. Also, the water blocking composition does not to be scraped off from each conductor layer after it has been stranded.

The method according to the invention allows to improve the penetration of the interstices with the water blocking composition, while preventing an excess of the water blocking composition. This ensures minimal impact on the dimension and mass of the conductor, which helps to maintain flexibility, reduce material costs, and minimize any additional resistance that could affect the electrical performance.

Stand-alone scrapers may be used in one or several conductor layers to reduce excess water blocking composition resulting migrating past an application device and/or a scraping device at stand-still of the system for manufacturing the power cable.

The method may comprise the step of winding one or more tapes around the conductor to create at least one tape layer, wherein the at least one tape layer may be configured to block water longitudinally. If the at least one tape layer contacts water, a swelling agent in the at least one tape layer may swell and thus block water in its vicinity. If there is a swelling agent in the at least one tape layer, the swelling agent may be embedded in or attached to a tape to form a swellable tape. A non-swellable tape may be used together with a swellable tape. Also, the at least one tape layer may be configured to prevent the water blocking composition from leaking through the at least one tape layer. This ensures that the water blocking composition remains in place in and on the conductor of the power cable. In the process of manufacturing the power cable, the conductor, i.e. the entirety of the conductor layers produced as described above, may be fed into a so-called tower line, where the conductor is heated up to a second temperature of e.g. 100° C. to 200° C., preferably of about 150° C. to about 170° C. Furthermore, a tensioning force is applied onto the conductor. Heating to the second temperature may be accomplished by inductive heating. By the elevated temperature and the tensioning force, the water blocking composition may have the tendency to expand, penetrate into the interstices of neighboring conductor layers and leak from the interstices of an outermost layer to a perimeter of the outermost layer. As will be described further below, in the tower line at least one additional layer, e.g. an inner semiconducting layer, an outer semiconducting layer, an insulation layer or the like may be applied. Particularly, the semiconducting layers may be cross-linked. By using the tape wound around the conductor, a mixing of the water blocking composition and the at least one additional layer can be avoided.

The tape may be wound around the conductor under tension and may form a plurality of tape layers, wherein the tape layers may be configured to prevent an expansion of the water blocking composition beyond the conductor. The tape may thus be wound tightly and under significant tension around the conductor to counteract the force of the expansion of the water blocking composition. Winding the tape under tension ensures that it creates a compressive force on the water blocking composition, which restricts its ability to expand beyond the confines of the tape. The tension during the winding process may induce a pre-stress condition in the tape layers, enhancing their mechanical resistance to the pressure exerted by the expanding water blocking composition. Furthermore, the tape may be wound in overlapping layers to provide uniform coverage and to distribute the restraining force evenly across the entire surface of the conductor. The tight winding under tension ensures that the expansion of the water blocking composition is constrained longitudinally and radially.

The method step of winding the tape may be performed by lapping the tape around the conductor. When lapping the tape, the tape overlaps with the tape of the foregoing turn of the tape.

The tape may also extend along a longitudinal direction. One or several elongated tape segments may be arranged on the conductor in a primarily longitudinal direction. Neighboring tape segments may overlap each other. Several layers of these tape segments may be created. Longitudinally arranged tape segments and tape layers wound around the conductor can be mixed. For example, one or more helical layers of tape may be created, on which one or more longitudinal layers are arranged, or vice versa. Also, layers with these different geometries may be arranged in an alternating manner around the conductor.

The tape may comprise a removable protective tape on top. The protective tape may be removed after winding the tape on the conductor. The winding of the tape may be done in a way that a ripping or the creation of holes can be avoided. This could be achieved by applying more tape, by using suitable supports that guide and hold the tape on the conductor during the winding, and/or by having the protective tape on top or around the at least one tape layer. This could, however, also be achieved by selecting a suitably strong tape.

The method may comprise adding a softening component with a lower viscosity than the water blocking composition to the water blocking composition before applying the water blocking composition, and drying and/or degassing the water blocking composition after applying it to the conductor elements. For some conductor designs like those made with profile wires, clearances to be sealed might be quite small (of a size of 1 mm or lower). Therefore, a water blocking composition with a lower viscosity may be needed to fill these small interstices when forming the conductors as described above. The low viscosity of the water blocking composition is detrimental for the later cable manufacturing processes and the overall function of the power cable. Thus, a temporary low-viscosity (softening) component may be introduced into the water blocking compositions in order to correctly fill the interstices in the conductor layers and then remove the low-viscosity component in a degassing step as set forth below. Such temporary low-viscosity component may be any solvent with low boiling temperatures diluting the polymer phase of the water blocking composition, for example alcohols, diethyl ether, acetone, isobutanol, isopropanol, heptane, toluene, xylene and a low-molecular weight (Mw˜1000 or lower) compounds such as polyisobutylene and modifications thereof. The mass fraction of the softening component can be from 0.1 to 30%. The complex viscosity of the water blocking composition with the low-viscosity component should be in the range of 1000 and 15000 Pa·s at processing temperatures indicated above. This viscosity could e.g. be measured by an oscillating rheometer equipped with parallel plate probes at 1 Hz frequency and 0.1% strain amplitude.

The method may comprise drying and/or degassing the water blocking composition before the applying. A drying or degassing process may depend on the specific configuration of the water blocking composition. A goal of this process step lies in removal of solvents and other volatile substances in the water blocking composition, which may be essential for correct function of the water blocking composition and controlling the thermal expansion after applying it to the conductor elements. This may improve the electric characteristics of the power cable and ensure long-term stability. This process step may include circulating the water blocking composition in a controlled temperature environment and/or under a vacuum. The application of a dried/degassed water blocking composition results in a more stable behavior in, for example, subsequent continuous vulcanization line processes, and reduces the risk of volatile substance migration into the insulation system of the power cable, which may lead to negative effects on the electrical properties.

The scraping off may comprise feeding the conductor with its current number of conductor layers through an opening cross section of a scraping device, wherein the feeding may comprise centering the current outermost conductor layer and the opening cross section of the scraping device relative to each other. The centering process prevents an off-center position of the conductor in its current state in the opening cross section, such that a gap created between the current outermost conductor layer and the opening cross section is constant. This allows to minimize the gap size and thus the thickness and overall volume and mass of the water blocking composition. To center the current outermost conductor layer relative to the opening cross-section of the scraping device, precise alignment mechanisms may be employed. This may involve using guide elements, such as tapered funnel sections or conical collar sections, that gradually align the current outermost conductor layer as it is inserted. The opening cross section of the scraping device may, for example, be arranged at a narrow end of a funnel or cone. As an alternative, active centering mechanisms, such as spring-loaded centering pins or actuated arms, may dynamically adjust the position of the current outermost conductor layer based on feedback from sensors that are configured to detect misalignment.

The stranding may comprise forming a plurality of conductor layers, wherein the water blocking composition may be applied to only a subset of the conductor layers. The conductor layers may preferably be concentrically arranged, with each successive layer enclosing the previous one, forming a substantially cylindrical structure. The stranding process enhances mechanical flexibility and, in case of AC and Milliken power cables, distributes electrical current uniformly across the conductor, reducing resistive losses and mechanical stress. The term “only a subset of the conductor layers” shall be understood by a skilled person to mean that not all, but a limited and, as mentioned further below, specific number of the total layers in the conductor are included. This subset may comprise certain conductor layers, which, if they comprise more than one layer, do not need to be consecutive conductor layers. The remaining conductor layers that are not included in the subset, are excluded from an application of the water blocking composition.

The method may comprise following steps after winding the tape: heating the conductor to a second temperature, applying a tension force onto the conductor, and forming an inner semiconductive layer, an insulation layer and an outer semiconductive layer enclosing the conductor to form the power cable. As mentioned above, the heating to the second temperature and the applying of a tension force, i.e. a tension force along the longitudinal direction of the conductor, may be conducted in a tower line. Here, the conductor is heated up to a second temperature of e.g. 100° C. to 200° C., preferably of about 150° C. to about 170° C. Furthermore, a tensioning force is applied onto the conductor. The inner semiconductive layer may be extruded directly onto the heated conductor. At the same time or afterwards, an insulation layer made of cross-linked polyethylene (XLPE) or another suitable material may be extruded onto the inner semiconductive layer. This insulation layer may provide a primary electrical insulation and may preferably be applied with precision to maintain a uniform thickness. At the same time or afterwards, the outer semiconductive layer may be extruded over the insulation layer to shield it electrically and provide a smooth interface for a cable sheath. As indicated by the term “tower line”, these steps may be typically carried out in a continuous, vertical arrangement. Due to the elevated temperature and the tensioning force, the water blocking composition may have the tendency to expand, penetrate into the interstices of neighboring conductor layers and leak from the interstices of an outermost layer to a perimeter of the outermost layer. By using the tape tightly wound around the conductor, a mixing of the water blocking composition and the at least one additional layer can be avoided.

The amount of water blocking composition and the subset of the conductor layers may be selected to fill at least one remaining, previously unfilled conductor layer with the water blocking composition driven by the tension force and heat-induced expansion. As mentioned above, the water blocking composition may expand by the exertion of heat and tensioning force. If not all conductor layers comprise the water blocking composition, the water blocking composition will expand upon heating to the second temperature and applying the tensioning force. Due to the tape, the water blocking composition is held within the confines of the conductor during this expansion. The water blocking composition will penetrate into and through neighboring conductor layers, in which interstices are not filled with the water blocking composition, by a substantially even distribution. Consequently, when the subset and the total amount of the water blocking composition is suitable selected, it can be assured that at least the outermost and/or innermost conductor layer(s) is/are filled with the water blocking composition. For example, at least two outermost conductor layers may afterwards be filled with the water blocking composition. If desired, for example, at least the innermost conductor layer(s) may afterwards be filled with the water blocking composition. With the method according to the invention, all conductor layers of the power cable may be filled without resulting in an excessive coating thickness.

The water blocking composition may comprise
20-95 wt.-% polymer base comprising a polymer selected from polyisoprene, butyl rubber, polyisobutylene, neoprene, ethylene propylene rubber, ethylene propylene diene monomer rubber, ethylene-octene, styrene ethylene butadiene styrene, polyurethanes and silicone rubber;
optional 0-40 wt.-% inert component;
5-50 wt.-% conductive filler.

As for the polymer base, polyisobutylene may be most preferred. The water blocking composition may be a specifically manufactured polymer based water blocking composition with special rheological properties and chemical composition.

The water blocking composition may contain inert components to increase the viscosity of the filling compound at temperatures relevant for manufacturing process (i.e. vulcanization at a temperature of 150° C.).

The term “inert component” as used herein refers to a compound not providing conductivity and where the core of the inert component does not undergo a chemical reaction with the other elements of the conductor filling compound or the conductor strands.

The inert component may be selected from one or more of calcium carbonate, talk, titanium dioxide, silicon dioxide, magnesium dioxide, borosilicate and other types of glass in the form of glass beads or fibers, including hollow glass beads. It will also be possible to include a combination of two or more of these compounds in the water blocking composition.

The complex viscosity of the water blocking composition at 150° C. may be between 10 and 300 kPa·s. The term “complex viscosity” as used herein refers to viscosity measured by an oscillating rheometer operating with a parallel plate probe at 1 Hz frequency and 0.1% strain amplitude. It is acknowledged that that the complex viscosity refers to the water blocking composition as a whole.

The conductive filler may be selected from one or more of the following: carbon black, graphite, carbon fibers, potassium titanate fibers, carbon nano-tubes, graphene or metallic powder like aluminum, copper or silver. It will also be possible to include a combination of two or more of these compounds in the water blocking composition.

The conductive filler may have a particle size distribution of 5 nm to 100 μm. A person skilled in the art will appreciate that this is to be understood that at least 95 wt.-% of the particles have an average size within the defined range, preferably 98 wt.-%.

The polymer base may comprise one or more additional polymers selected from polyisoprene, polybutadiene, butyl rubber, neoprene, polyurethanes, ethylene propylene rubber, ethylene propylene diene monomer rubber, ethylene-octene, styrene ethylene butadiene styrene and silicone rubber. It is preferred that these are used besides the polyisobutylene.

The content of volatile chemicals in the water blocking composition may be <1.5 wt.-%, when measured via TGA after the degassing step. When the TGA is performed with isothermal step at 200° C. for 1 h, sample mass is 60±10 mg.

The volume expansion of the water blocking composition may be less than 10%, preferably less than 5%, more preferably less than 4%, when measured at 150° C. compared to room temperature at atmospheric pressure.

The water blocking composition may further comprise a contracting filler, wherein the contracting filler contracts upon heating. In embodiments of this aspect, the contracting filler can be any suitable material having a negative thermal expansion coefficient (CTE) of −1×10⁻⁶° C.⁻¹ and lower. Examples of such materials are metal tungstates, metal phosphates, metal molybdates, metal vanadates, metal arsenates, metal oxides (glass ceramics), and metal nitrides, as disclosed in U.S. Pat. Nos. 5,322,559, 5,433,720, 5,514,360, 5,919,720, 6,521,556, and 7,632,480. A similar effect can also be achieved by adding other compounds as well as substances undergoing phase transformations over a certain temperature range of 30-90° C.

The preferred fillers are bismuth nickelates (general chemical formula Bi₁₋ₓMₓNiO₃, where M represents a metal and x is a numerical value from 0 to 0.2), zirconium tungstate (chemical formula ZrW₂O₈), hafnium tungstate (HfW₂O₈), Zr₂P₂WO₁₂, Hf₂P₂WO₁₂, and magnetic nanocrystalline materials, such as CuO-nanocrystals, conductive nano-fibers such as carbon nano-tubes, metal alloys like Invar Fe₃Pt, or MnCoGe- or MnCoGeN-based alloys.

The contracting filler may be present at 0.1-30 wt.-% in the water blocking composition.

The invention further relates to a system for manufacturing an electric power cable, comprising a stranding die for stranding conductor elements onto at least one conductor layer to form a conductor, an applicator device configured to apply a water blocking composition to the conductor elements in a stranding region during the stranding, such that interstices between the conductor elements comprise the water blocking composition, a first heating device for heating the stranding region to a first temperature, and a scraping device for scraping off a part of the water blocking composition to adjust a layer thickness of the water blocking composition on the current outermost conductor layer to a predetermined level, wherein the scraping device is arranged behind the stranding die and the applicator device along a manufacturing flow direction.

The system may further comprise a tape winding device for winding at least one tape layer around the conductor. The tape winding device may comprise a compaction roller that is configured for rolling along the periphery of the conductor thereby pressing the tape onto the conductor. A tape supply device, such as a spool, may be mounted on a spindle that allows controlled unwinding of the tape. The tape may be guided through an alignment system, ensuring accurate positioning relative to the conductor. A drive system, which may preferably be motorized, may move the compaction roller around a longitudinal axis of the conductor while simultaneously advancing the tape along the conductor to achieve uniform winding. The winding path and tension may be controlled by a combination of sensors and feedback systems to maintain tight and consistent application of the tape, and the forming of desired overlaps.

The tape winding device may be configured to wind the tape onto the conductor under tension. For this, the tape winding device may comprise a tensioning mechanism, such as adjustable guiding rollers or a braking system to control the mechanical tension of the tape as it is unwound.

The system may comprise a second heating device for heating the conductor to a second temperature, a tensioning arrangement for applying a tensioning force onto the conductor, and an extrusion head assembly for providing an inner semiconductive layer, an insulation layer and an outer semiconductive layer enclosing the conductor. The tensioning may be accomplished by conducting a vertical extrusion, in which the conductor may be guided in an elevated position of a tower vertically down into an extrusion head. Also in horizontal processes, such as in a catenary continuous vulcanizing line, there may be a certain tension. The tension is used to ensure the cable is centered for the process steps to be realized. A tension beyond just gravity can be used in some cases. For example, the cable may be wound onto a reel in a lower position in the tower, maintaining a desired tension throughout the process. Thus, the tensioning arrangement may include a guide at the elevated position as well as a winding mechanism at the lower position. The extrusion head assembly used for providing the inner semiconductive layer, the insulation layer, and the outer semiconductive layer may be provided in the form of a co-extrusion triple-layer extrusion head, which may be capable of simultaneously extruding all three layers onto the conductor in a continuous and concentric manner.

The invention also relates to a power cable obtained by the method according to the above.

Lastly, the invention relates to the use of a power cable according to the above in subsea applications. For example, the power cable may be used in more than 3.000 m under the sea level. The power cable may be used under a pressure of more than 0 MPa to 60 MPa, preferably 1 MPa to 40 MPa, more preferred 5 MPa to 30 MPa, most preferred 5 MPa to 25 MPa. The method of manufacturing the power cable according to the present invention enables the provision of an improved power cable which withstands higher pressures in large subsea water depths. The power cable may be used under a pressure of up to 400 bar.

The power cable may comprise between one and three cable cores. The power cable with one cable core may preferably represent a high voltage direct current (HVDC) power cable. The power cable with three cable cores may preferably represent a high voltage alternating current (HVAC) power cable. The power cable according to the invention may preferably be a high voltage cable.

The term “high voltage” in the framework of the present application means voltages of 36 kV or more (IEC terms >36 kV). Such cables benefit the most from the features according to the invention as discussed herein. With increasing voltage or power transmitted, the power cable requires increased cable core diameters. The feature according to which more than one layer is applied provides improved properties of the water blocking composition especially when in case of cable cores being larger in diameter. The power cable may be even designed for voltages of 100 kV or higher, 320 kV or higher, or 525 kV or higher. The power cable may further be configured to withstand operating temperatures of 80 or 90° C. and above.

### SHORT DESCRIPTION OF THE DRAWINGS

In the following description this invention will be further explained by way of exemplary embodiments shown in the drawings:

FIG. 1 shows a schematic sectional view of a power cable.

FIG. 2 shows a schematic view of a system for manufacturing a power cable.

FIG. 3 shows a schematic block-oriented view of a method of manufacturing an electric power cable.

### DETAILED DESCRIPTION OF THE INVENTION

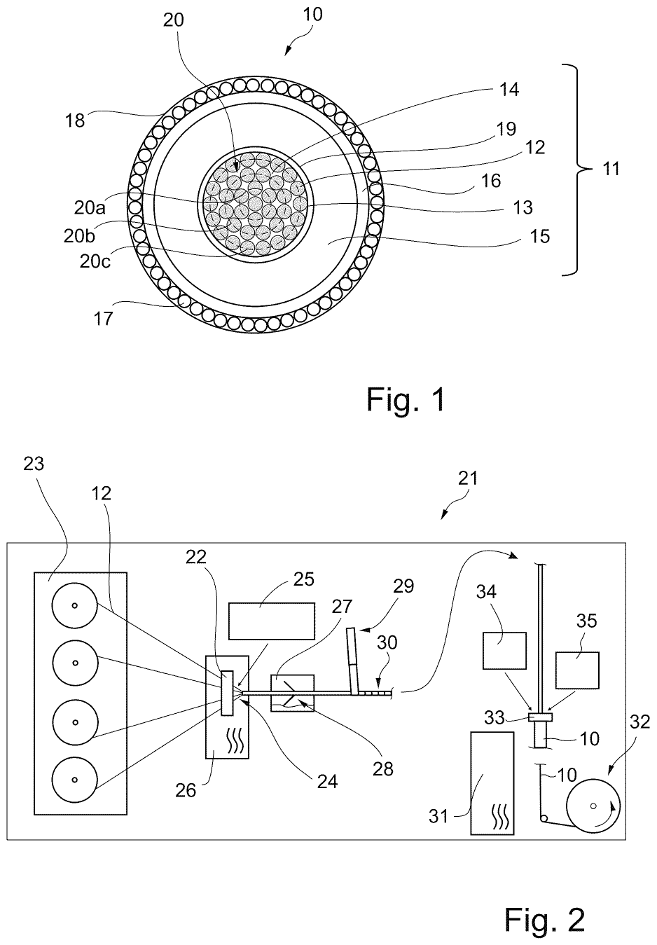

FIG. 1 shows a schematic and exemplary sectional view of a power cable 10. The power cable 10 has a cable core 11, which comprises a conductor 20 having a plurality of concentric conductor layers 20a, 20b and 20c. The skilled person will understand that the number of conductor layers may differ depending on the requirements of the cable 10. The layers 20a, 20b and 20c are produced by stranding the conductor elements 12 and have a substantially circular shape in the sectional plane perpendicular to a longitudinal axis of the cable 10.

The conductor layers 20a, 20b and 20c are formed by stranded conductor elements 12. Between the conductor elements 12, voids 14, which may also be referred to as interstices, are formed. These are filled with a water blocking composition in order to avoid water ingress within the conductor layers 20a, 20b and 20c. A tape 13 is wound around the outermost conductor layer 20c. An inner semiconductive layer 19 encloses the conductor 20 and is thus in close contact to a radial outer surface of the tape 13. An electrically insulating layer 15 follows on in a radial direction and is enclosed by an outer semiconductive layer 16.

The cable core 11 is exemplarily surrounded by an armoring layer 17, which is covered by an outer sheath 18. The power cable 10 may also have additional layers that are not shown herein, depending on the requirements for the power cable 10. The scope of protection is not limited to the exemplary embodiment shown in this drawing.

FIG. 2 shows a schematic and exemplary view of a system 21 for manufacturing the power cable 10 of FIG. 1. The skilled person will understand how the individual elements shown in FIG. 2 may be chosen, dimensioned and constructed. The illustration shall merely show the general concept of the system 21.

The system 21 comprises a stranding die 22 for stranding the conductor elements 12 onto the conductor layers 20a, 20b and 20c to form the conductor 20. The conductor elements 12 may be fed from several spools 23. The stranding die 22 and the number of spools 23 and conductor elements 12 may be chosen according to the intended setup of the cable 10. It is not ruled out that a plurality of stranding dies 22 is used, wherein each of the stranding dies 22 is directed to manufacturing one of the conductor layers 20a, 20b and 20c.

The conductor elements 12 are fed together in a stranding region 24, which might be arranged in a location directly after passing the stranding die 22. An applicator device 25 is provided, which is configured to apply a water blocking composition to the conductor elements 12 in the stranding region 24 during the stranding, such that the interstices 14 between the conductor elements 12 comprise the water blocking composition. A first heating device 26 is provided for heating the stranding region 24 to a first temperature. This improves the application of the water blocking composition, as the viscosity of the water blocking composition may be reduced.

Exemplarily, a scraping device 27 is arranged behind the stranding region 24 in a flow direction of the process of the system 21. The scraping device 27, which is exemplarily shown to have a scraping cone 28, scrapes off the water blocking composition from the current outermost conductor layer, which in this example is the conductor layer 20c, to adjust a layer thickness of the water blocking composition to a predetermined level.

For enclosing the conductor 20 and the water blocking composition arranged in the interstices 14, a tape winding device 29 is provided behind the scraping device 27 in a manufacturing flow direction. The tape winding device 29 is configured for winding a tape 30 around the conductor 20. Preferably, the tape winding device 29 is configured to wind the tape 30 onto the conductor 20 under tension.

In the viewing plane of FIG. 2 on the right-hand side, a tower line shall be indicated. Here, a second heating device 31 is provided for heating the conductor 20, which has the tape 30 tightly wound on it, to a second temperature. A tensioning device 32 in the form of a winding mechanism is used for applying a tensioning force onto the conductor 20, which is exemplarily arranged vertically. An extrusion head assembly 33, which is merely indicated here, is configured for providing the inner semiconductive layer 19, the insulation layer 15 and the outer semiconductive layer 16 enclosing the conductor 20. The extrusion head assembly 33 is supplied with suitable material from material supply units 34 and 35. As mentioned above, the drawing is merely schematic and the skilled person will understand how to design the system 21 according to the requirements for the power cable 10.

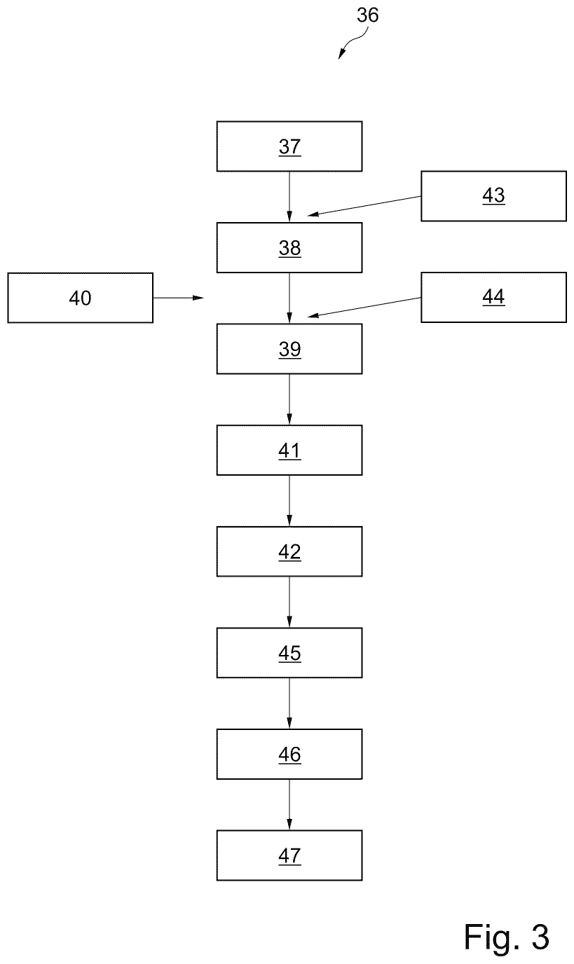

FIG. 3 shows a schematic illustration of a method 36 for manufacturing an electric power cable 10. The method comprises providing 37 a plurality of conductor elements 12, stranding 38 the conductor elements 12 to combine the conductor elements 12 into at least one conductor layer 20a, 20b, or 20c to form a conductor 20, applying 39 a water blocking composition to the conductor elements 12 in a stranding region 24 during the stranding, such that interstices 14 between the conductor elements 12 comprise the water blocking composition, heating 40 the stranding region 24 and/or the water blocking composition to a first temperature during the applying, and scraping off 41 a part of the water blocking composition to adjust a layer thickness of the water blocking composition on the at least one conductor layer 20a, 20b, or 20c to a predetermined level. The water blocking composition may be applied to only a subset of the conductor layers 20a, 20b, or 20c, if a plurality of conductor layers 20a, 20b or 20c is produced.

Afterwards, the method comprises winding 42 a tape 30 around the conductor (20) to create at least one tape layer, wherein the at least one tape layer is configured to block water. This might be done under tension and forms a plurality of tape layers, wherein the tape layers are configured to prevent an expansion of the water blocking composition beyond the conductor 20.

Before the water blocking composition is applied, a softening component with a lower viscosity than the water blocking composition could be added 43 to the water blocking composition. After applying, the water blocking composition may then be dried and/or degassed 44.

After winding 42 the tape 30, the method 36 may comprise heating 45 the conductor 20 to a second temperature, applying 46 a tension force onto the conductor 20, and forming 47 an inner semiconductive layer 19, an insulation layer 15 and an outer semiconductive layer 16 enclosing the conductor 20 to form the power cable 10.

### REFERENCE NUMERALS

10 power cable
11 cable core
12 conductor element
13 tape
14 void/interstice
15 electrically insulating layer
16 outer semiconductive layer
17 armoring
18 outer sheath
19 inner semiconductor layer
conductor
20a, 20b, 20c conductor layer
21 system for manufacturing a power cable
22 stranding die
23 spool
24 stranding region
25 applicator device
26 first heating device
27 scraping device
28 scraping cone
29 tape winding device
30 tape
31 second heating device
32 tensioning device
33 extrusion head assembly
34 material supply unit
35 material supply unit
36 method
37 providing conductor elements
38 stranding
39 applying water blocking composition
40 heating to first temperature
41 scraping off
42 winding tape
43 adding softening component
44 drying/degassing
45 heating to second temperature
46 applying tension force
47 forming semiconductive/insulation layers

1. Method of manufacturing an electric power cable, wherein the method comprises:
providing a plurality of conductor elements,
stranding the conductor elements to combine the conductor elements into at least one conductor layer to form a conductor,
applying a water-blocking composition to the conductor elements in a stranding region during the stranding, such that interstices between the conductor elements comprise the water blocking composition,
heating the conductor elements before and/or during entering the stranding region and/or the water blocking composition to a first temperature during the applying, and
scraping off a part of the water blocking composition to adjust a layer thickness of the water blocking composition on the at least one conductor layer to a predetermined level,
wherein the water blocking composition is configured to prevent water ingress within the at least one conductor layer.

2. The method according to claim 1, the method comprising:
winding a tape around the conductor to create at least one tape layer,
wherein the at least one tape layer is configured to block water.

3. The method according to claim 2,
wherein the tape is wound around the conductor under tension and forms a plurality of tape layers, and
wherein the tape layers are configured to prevent an expansion of the water blocking composition beyond the tape.

4. Method according to claim 1, the method comprising:
adding a softening component with a lower viscosity than the water blocking composition to the water blocking composition before applying the water blocking composition, and
drying and/or degassing the water blocking composition after applying it to the conductor elements.

5. The method according to claim 1,
wherein the scraping off comprises feeding the conductor with its current number of conductor layers through an opening cross section of a scraping device, and
wherein the feeding comprises centering the current outermost conductor layer and the opening cross section of the scraping device relative to each other.

6. The method according to claim 1,
wherein the stranding comprises forming a plurality of conductor layers, and
wherein the water blocking composition is applied to only a subset of the conductor layers.

7. The method according to claim 1, the method comprising following steps after winding the tape:
heating the conductor to a second temperature,
applying a tension force onto the conductor, and
forming an inner semiconductive layer, an insulation layer and an outer semiconductive layer enclosing the conductor to form the power cable.

8. The method according to claim 7, when dependent on claim 6,
wherein the amount of water blocking composition and the subset of conductor layers are selected to fill at least one remaining, previously unfilled conductor layer with the water blocking composition driven by the tension force and heat-induced expansion of the water blocking composition.

9. System for manufacturing an electric power cable, comprising:
a stranding die for stranding conductor elements onto at least one conductor layer to form a conductor,
an applicator device configured to apply a water blocking composition to the conductor elements in a stranding region during the stranding, such that interstices between the conductor elements comprise the water blocking composition,
a first heating device for heating the stranding region to a first temperature, and
a scraping device for scraping off a part of the water blocking composition to adjust a layer thickness of the water blocking composition on the current outermost conductor layer to a predetermined level,
wherein the scraping device is arranged behind the stranding die and the applicator device along a manufacturing flow direction.

10. The system according to claim 9, comprising:
a tape winding device for winding the tape around the conductor.

11. The system according to claim 10, comprising:
wherein the tape winding device is configured to wind the tape onto the conductor under tension.

12. The system according to claim 9, comprising:
a second heating device for heating the conductor to a second temperature,
a tensioning device for applying a tensioning force onto the conductor, and
an extrusion head assembly for providing an inner semiconductive layer, an insulation layer and an outer semiconductive layer enclosing the conductor.

13. A power cable obtained by the method according to claim 1.

14. The power cable of claim 13,
wherein the power cable is designed to for voltages of 36 kV or higher, 100 kV or higher, 320 kV or higher, or 525 kV or higher.

15. Use of a power cable according to claim 13 in subsea applications.
